(19) United States
(12) Patent Application Publication
(10) Pub. No.: US 2008/0188961 A1
(43) Pub. Date: Aug. 7, 2008

(54) GEMSTONE WEIGHT CALCULATING METHOD AND SYSTEM

(76) Inventor: Paul David Marcum, Cape Coral, FL (US)

Correspondence Address: EDWARD M. LIVINGSTON, PA, 963 TRAIL TERRACE DRIVE, NAPLES, FL, 34103, US

(21) Appl. No.: 11/671,715

(22) Filed: Feb. 6, 2007

(51) Int. Cl. G06F 17/10; A44C 17/00

(52) U.S. Cl. 700/89; 700/90; 63/32

(57) ABSTRACT

A method of calculating a weight of a gemstone via an electronic device by selecting at least one gemstone characteristic from a list of predetermined gemstone characteristics wherein the device calculates a weight of a gemstone by processing the at least one gemstone characteristic within a gemstone weight algorithm and displays the resulting weight on the electronic device. The gemstone characteristics include a gemstone type, a gemstone shape, a gemstone outline, a gemstone girdle and a gemstone bulge. In addition, a user of the method enters a gemstone size into the electronic device. A user may select in which order he/she selects a gemstone characteristic or enters a gemstone weight and may navigate to and from each characteristic. Once the user selects the appropriate gemstone characteristics, a gemstone weight algorithm performs the appropriate calculations so as to determine the weight of the gemstone. Thus, a person need not manually perform the calculations associated with calculating a weight of a gemstone.

### BACKGROUND OF THE INVENTION

This invention relates to methods of calculating a gemstone weight, more specifically, a gemstone weight calculating method and system that permits a person to quickly and easily calculate the weight of a gemstone by using a variety of input factors.

When determining the weight, and thus value, of a gemstone, a person must carefully measure the dimensions of the gemstone and perform a series of lengthy and time-consuming calculations which take into consideration various factors of the gemstone itself, such as the type of gemstone itself, as well as its shape, outline, girdle and bulge. The exact and precise measurements of the gemstone are of utmost importance when calculating a gemstone's weight as a thousandth of a carat could greatly impact the total value of the gemstone.

In addition, the calculations are so complex in nature that a person must use a calculator in order to accurately perform the calculations. Thus, if a person is not carrying a calculator at a time when the weight of a gemstone need be determined, then he or she will most likely be unable to determine the weight of the gemstone. However, even if a person is carrying a calculator, the amount of time needed to perform the calculations could exceed the amount of time in which a person has to determine the weight, as is the case in auctions.

Although there are several methods for calculating the weight of a gemstone, including the usage of a handheld digital gemstone measurement apparatus, the current methods do not permit a user to calculate the weight of a gemstone by utilizing electronic devices that are commonly owned by consumers, such as computers, personal digital assistants, etc..

Thus, a need exists for a new gemstone weight calculating method and software that permits a person to quickly and easily calculate the weight of a gemstone by using a variety of input factors when using an electronic device.

The relevant prior art includes the following patents:

| U.S. Pat. No. | | |
|---|---|---|
| (U.S. unless | | |
| stated otherwise) | Inventor | Issue Date |
| 4,845,646 | Marquis et al. | Jul. 04, 1989 |
| 2005/0069858 | Lapa et al. | Mar. 31, 2005 |
| 6,980,283 | Aggarwal | Dec. 27, 2005 |
| 2005/0149369 | Sevdermish | Jul. 07, 2005 |
| 2005/0213077 | Sasian et al. | Sep. 29, 2005 |
| 2006/0074588 | Blodgett et al. | Apr. 06, 2006 |
| 2006/0164623 | Wagner et al. | Jul. 27, 2006 |

### SUMMARY OF THE INVENTION

The primary object of the present invention is to provide a method of calculating a weight of a gemstone by selecting various gemstone characteristics from a list of predetermined gemstone characteristics.

Another object of the present invention is to provide a method of calculating a weight of a gemstone quickly and easily.

An even further object of the present invention is to provide a method of calculating a weight of a gemstone by using an electronic device.

The present invention fulfills the above and other objects by providing a method and system for calculating a weight of a gemstone via an electronic device by selecting at least one gemstone characteristic from a list of predetermined gemstone characteristics wherein the device calculates a weight of a gemstone by processing the at least one gemstone characteristic within a gemstone weight algorithm and displaying the weight on the electronic device. The gemstone characteristics include a gemstone type, a gemstone shape, a gemstone outline, a gemstone girdle and a gemstone bulge. In addition, a user of the method enters a gemstone size into the electronic device. A user may select in which order he/she selects a gemstone characteristic or enters a gemstone weight and may navigate to and from each characteristic. Once the user selects the appropriate gemstone characteristics, a gemstone weight algorithm performs the appropriate calculations so as to determine the weight of the gemstone. Thus, a person need not manually perform the calculations associated with calculating a weight of a gemstone.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a flow diagram representing the screens of a method of calculating a weight of a gemstone of the present invention;

FIG. 2 is a detailed view of a gemstone screen of the present invention;

FIG. 3 is a detailed view of a gemstone shape screen of the present invention;

FIG. 4 is a detailed view of a gemstone size screen of the present invention;

FIG. 5 is a detailed view of a gemstone outline screen of the present invention;

FIG. 6 is a detailed view of a gemstone girdle screen of the present invention;

FIG. 7 is a detailed view of a gemstone bulge screen of the present invention; and

FIG. 8 is a detailed view of a gemstone weight results screen of the present invention.

### DESCRIPTION OF THE PREFERRED EMBODIMENTS

For purposes of describing the preferred embodiment, the terminology used in reference to the numbered components in the drawings is as follows:

| | |
|---|---|
| 1. | gemstone weight calculating |
| | method, generally |
| 2. | start |
| 3. | title screen |
| 4. | gemstone type screen |
| 5. | gemstone shape screen |
| 6. | gemstone size screen |
| 7. | gemstone outline screen |
| 8. | gemstone girdle screen |
| 9. | gemstone bulge screen |
| 10. | gemstone results screen |
| 11. | exit |
| 12. | reset |
| 13. | help |
| 14. | gemstone type list |
| 15. | select gemstone type |
| 16. | gemstone shape list |
| 17. | select gemstone shape |
| 18. | length entry box |
| 19. | width entry box |
| 20. | height entry box |
| 21. | gemstone outline list |
| 22. | select gemstone outline |
| 23. | gemstone girdle list |
| 24. | select gemstone girdle |
| 25. | gemstone bulge list |
| 26. | select gemstone bulge |
| 27. | gemstone weight |
| 28. | notes |
| 29. | gemstone type tab |
| 30. | gemstone shape tab |
| 31. | gemstone size tab |
| 32. | numerical entry pad |
| 33. | enter |
| 34. | gemstone outline tab |
| 35. | gemstone girdle tab |
| 36. | gemstone bulge tab |
| 37. | back |
| 38. | advance |
| 39. | results tab |
| 40. | continue button |
| 41. | gemstone icon |
| 42. | drop-down list |
| 43. | gemstone characteristic summary |

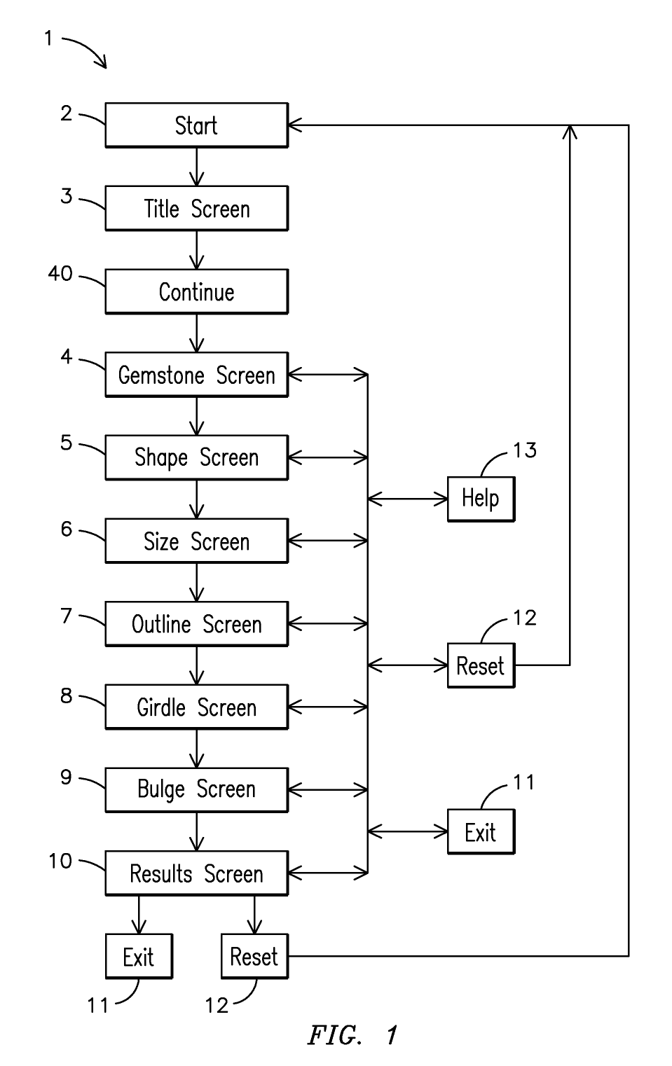

With reference to FIG. 1, a flow diagram representing the screens of a method of calculating a weight of a gemstone of the present invention is shown. The gemstone weight calculating method, generally 1, includes a plurality of screens having input fields to permit inputting of various gemstone characteristics therein. The gemstone weight calculating method 1 is preferably in the form of a computer software program wherein the program is installed in an electronic device, such as a personal computer, a laptop computer, a personal digital assistant, a calculator, etc. The electronic device should preferably include a display screen large enough in size to view at least one of the plurality of screens and a sufficient storage memory capable of downloading and saving the gemstone weight calculating method 1. To use the gemstone weight calculating method 1, a user first starts 2 the method to display a title screen 3. The title screen 3 indicates the gemstone weight calculating name and various legal notices. Once a user has reviewed the title screen 3, he/she may select a continue button 40 to proceed to a gemstone screen 4. In the alternative, a continue button 40 need not be included on the title screen 3 so long as gemstone weight calculating method 1 advances to a gemstone screen 4 after a predetermined amount of time.

Once the gemstone weight calculating method 1 has begun, a user may advance through a series of screens which permit the user to input various characteristics of a gemstone. Preferably, the screens include a gemstone shape screen 5, a gemstone size screen 6, a gemstone outline screen 7, a gemstone girdle screen 8 and a gemstone bulge screen 9. Once the various characteristics of a gemstone have been inputted into an appropriate section on the appropriate screen, a user views a results screen 10 so as to view the weight of the gemstone analyzed.

A user preferably proceeds with the gemstone weight calculating method 1 of the present invention by advancing from screen to screen in the following order: gemstone screen 4, gemstone shape screen 5, gemstone size screen 6, gemstone outline screen 7, gemstone girdle screen 8, gemstone bulge screen 9 and finally results screen 10. However, a user may skip over a screen, for instance, proceed from the gemstone size screen 6 to the gemstone girdle screen 8, or in the alternative, return to a previous screen, for instance, return to the gemstone shape screen 5 from the gemstone outline screen 7.

At anytime during the use of the gemstone weight calculating method 1 of the present invention, the user may exit 11 the method 1 entirely or, in the alternative, reset 12 the gemstone weight calculating method 1 so as to calculate a weight of a new gemstone by permitting the user to begin at the start 2. In addition, a help 13 feature is provided to permit a user to view a help text document in the event a user is unsure of how to use the gemstone weight calculating method 1.

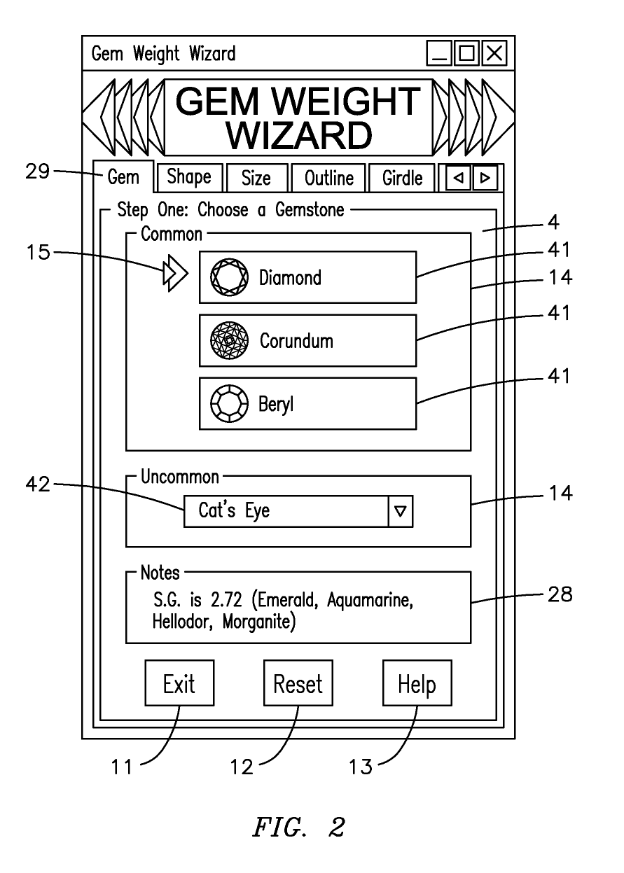

With reference to FIG. 2, a detailed view of a gemstone screen of the present invention is shown. The gemstone screen 4 permits a user to select a gemstone type 15 from a list of predetermined gemstone types 14. The predetermined gemstone type list 14 may be in the form of gemstone icons 41 or, in the alternative, may be in the form of a drop-down list 42. The exit 11 button, reset 12 button and help 13 button are preferably located on the gemstone screen 4 as well. In addition, a notes 28 section permits a user to manually enter any notes he/she may have regarding the gemstone. A gemstone type tab 29 is preferably located at a top of the gemstone screen 4 so as to indicate that the user is currently accessing the gemstone screen 4. Once the user has selected the gemstone type 15, he/she advances to a new screen by selecting an appropriate tab.

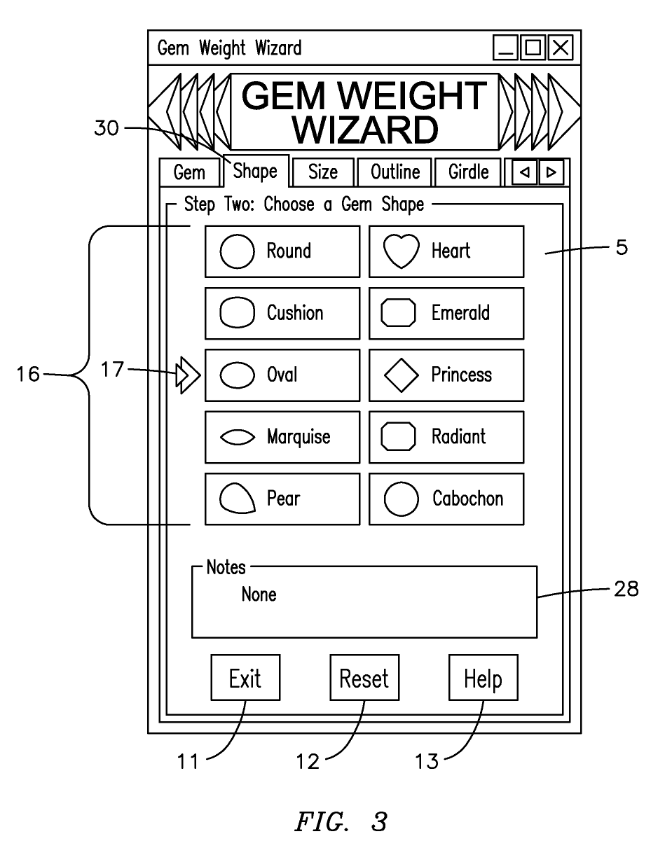

In FIG. 3, a detailed view of a gemstone shape screen of the present invention is shown. The gemstone shape screen 5 permits a user to select a particular shape of the gemstone being analyzed. A predetermined gemstone shape list 16 is displayed on the gemstone shape screen 5 wherein the list preferably includes the most popular gemstone shapes, such as round, cushion, oval, marquise, pear, heart, emerald, princess, radiant and cabochon; however, other shapes may also be included. A gemstone shape tab 30 indicates that the user is currently accessing the gemstone shape screen 5. Once the user has selected the gemstone shape 17, he/she advances to a new screen by selecting another tab.

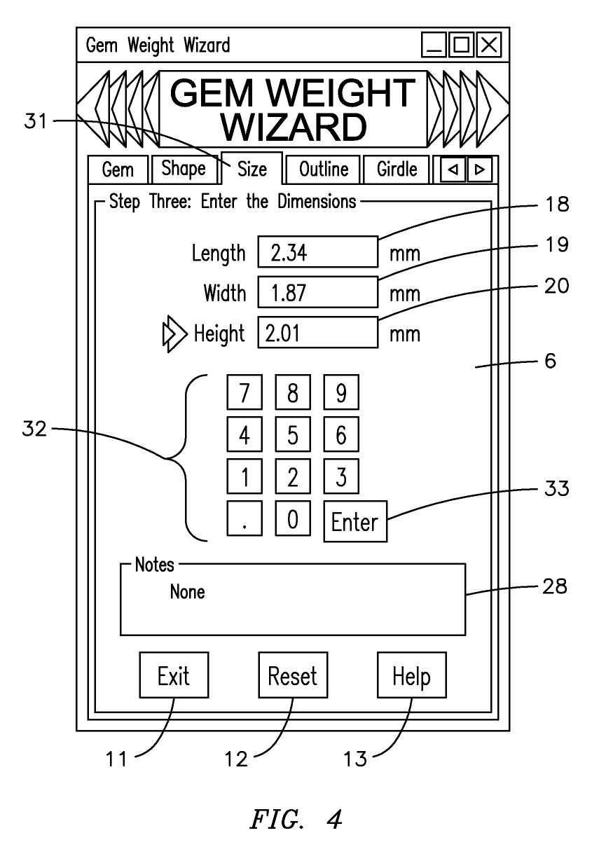

FIG. 4 shows a detailed view of a gemstone size screen of the present invention. The gemstone size screen 6 permits a user to manually enter various dimensions of the gemstone being analyzed by inputting a length in micrometers into a length entry box 18, a width in micrometers into a width entry box 19 and a height in micrometers into a height entry box 20. A numerical entry pad 32 may be provided on the gemstone size screen 6 to permit a user to input the appropriate measurements into the appropriate entry boxes 18-20, although a person may use numerical keys located on the electronic device as well. After a measurement is inputted into an entry box 18-20, the user selects the enter 33 button to move a cursor to the next entrybox 18-20. A gemstone size tab 31 indicates that the user is currently accessing the gemstone size screen 6 and advances to a new screen by selecting another tab.

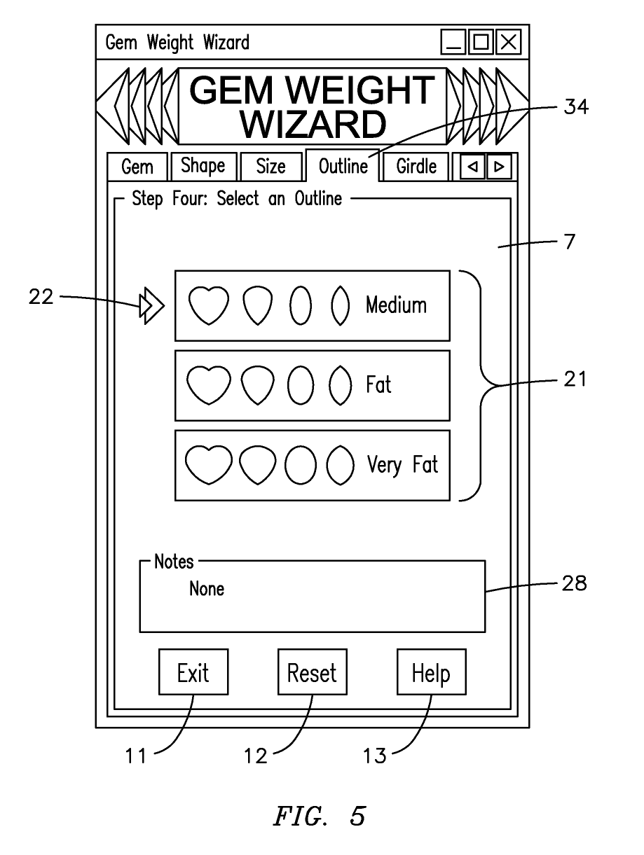

Next, FIG. 5 shows a detailed view of a gemstone outline screen of the present invention. The gemstone outline screen 7 displays a predetermined gemstone outline list 21, which may include medium, fat and very fat outlines. A user selects an outline 22 that most closely resembles the gemstone being analyzed and proceeds to a new screen.

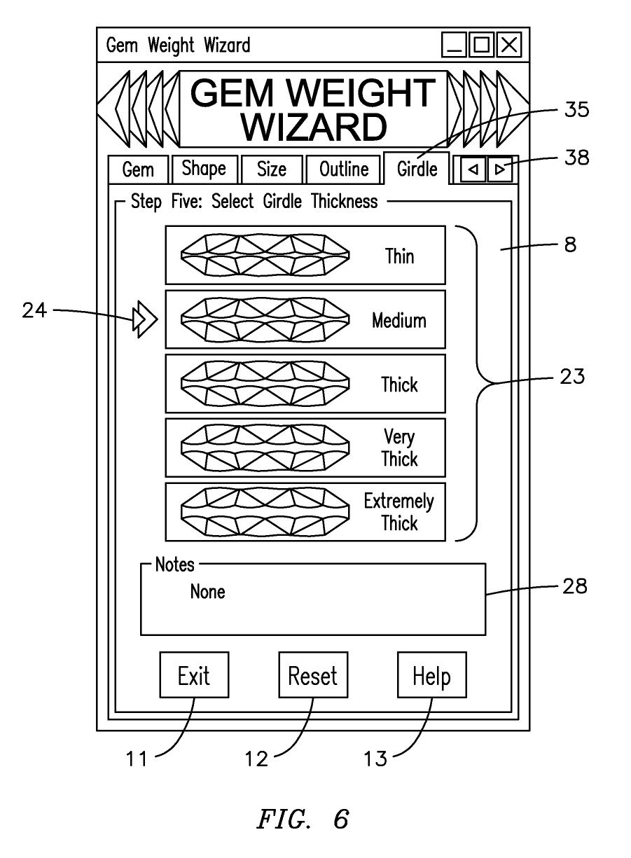

FIG. 6 shows a detailed view of a gemstone girdle screen of the present invention. The gemstone girdle screen 8 permits a user to select a girdle 24 from a list of predetermined girdles 23 which most closely resemble the girdle of the gemstone being analyzed. The gemstone girdle tab 35 indicates that the user is accessing the gemstone girdle screen 8. In order to view additional tabs and related screens, a user selects an advance 38 button that is preferably located in line with the tabs.

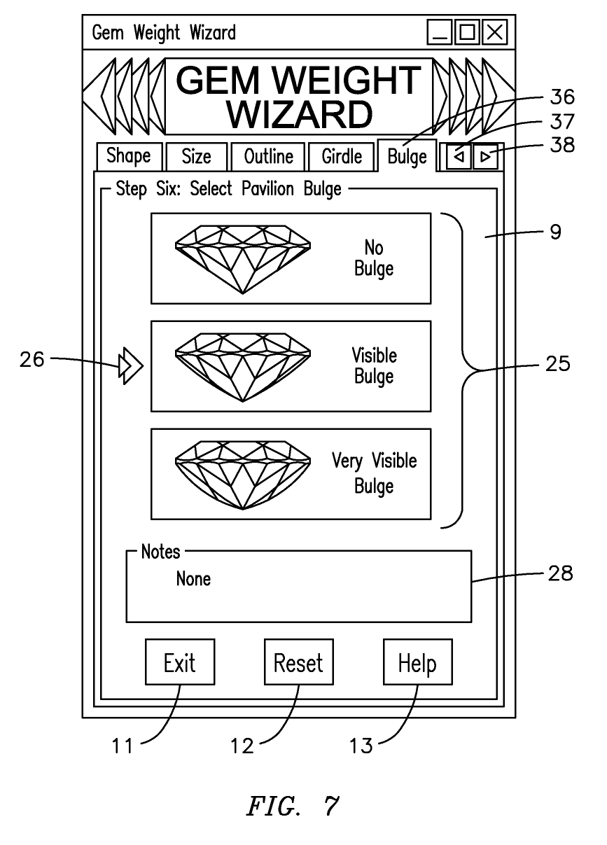

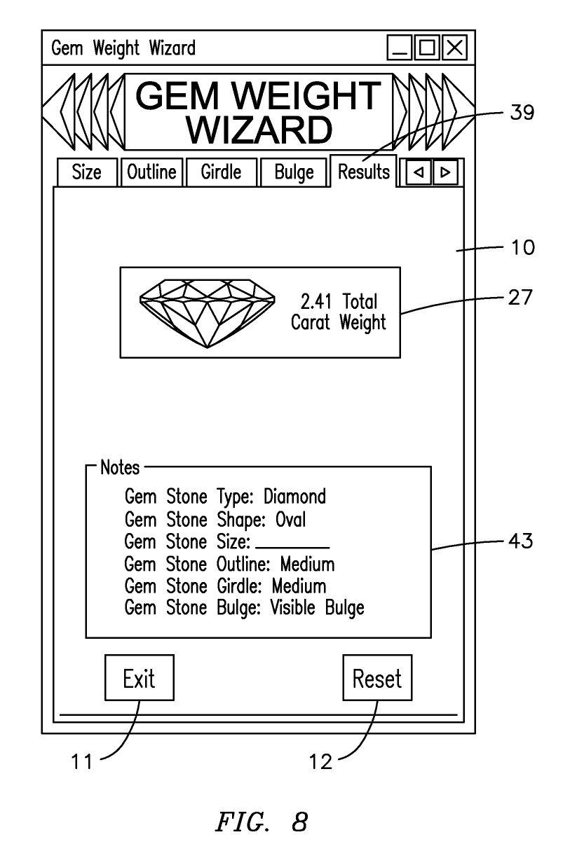

In FIG. 7, a detailed view of a gemstone bulge screen of the present invention is shown. The gemstone bulge screen 9 permits a user to select a bulge 26 which most closely resembles the gemstone being analyzed from a list of predetermined bulges 25. The predetermined bulge list 25 preferably includes no bulge, visible bulge and very visible bulge. To proceed with the method 1, a user selects the advance 38 button to view a final results screen 10 as shown in FIG. 8. Because not all of the tabs are visible at once, the user may navigate the tabs by selecting the back 37 button and the advance 38 button to view the desired tab and, thus, the desired screen.

Finally, FIG. 8 shows a detailed view of a gemstone weight results screen of the present invention. The results screen 10 displays a gemstone weight 27 as calculated by the various gemstone characteristics inputted by the user. A gemstone characteristic summary 43 is displayed on the gemstone results screen 10 along with the gemstone weight 27 so the user may quickly determine whether the gemstone characteristics he/she inputted were accurate.

Although only a few embodiments of the present invention have been described in detail hereinabove, all improvements and modifications to this invention within the scope or equivalents of the claims are included as part of this invention.

Having thus described my invention, I claim:

1. An electronic device implemented method of calculating a weight of a gemstone using an electronic device, said method comprising the steps of:
a. installing said method in an electronic device;
b. initiating said method in the electronic device;
c. selecting at least one gemstone characteristic from a list of predetermined gemstone characteristics;
d. calculating a weight of a gemstone by processing said at least one gemstone characteristic within a gemstone weight algorithm; and
e. displaying the gemstone weight on the electronic device.

2. The electronic device implemented method of claim 1 wherein:
said at least one gemstone characteristic is a type of gemstone selected from a list of predetermined gemstone types.

3. The electronic device implemented method of claim 1 wherein:
said at least one gemstone characteristic is a gemstone shape selected from a list of predetermined gemstone shapes.

4. The electronic device implemented method of claim 1 wherein:
said at least one gemstone characteristic is a gemstone size selected from a list of predetermined gemstone sizes.

5. The electronic device implemented method of claim 1 wherein:
said at least one gemstone characteristic is a gemstone outline selected from a list of predetermined gemstone outlines.

6. The electronic device implemented method of claim 1 wherein:
said at least one gemstone characteristic is a gemstone girdle selected from a list of predetermined gemstone girdles.

7. The electronic device implemented method of claim 1 wherein:
said at least one gemstone characteristic is a gemstone bulge selected from a list of predetermined gemstone bulges.

8. An electronic device implemented method of calculating a weight of a gemstone using an electronic device, said method comprising the steps of:
a. installing said method in an electronic device;
b. initiating said method in the electronic device;
c. selecting at least one gemstone shape from a list of predetermined gemstone shapes;
d. selecting at least one gemstone characteristic from a list of predetermined gemstone characteristics;
e. calculating a weight of a gemstone by processing said at least one gemstone characteristic within a gemstone weight algorithm; and
f. displaying the gemstone weight on the electronic device.

9. The electronic device implemented method of claim 8 wherein the list of predetermined gemstone shapes includes round, cushion, oval, marquise, pear, heart, emerald, princess, radiant and cabochon.

10. The electronic device implemented method of claim 8 and further comprising a step after step b of selecting a gemstone type from a list of predetermined gemstone types.

11. The electronic device implemented method of claim 8 and further comprising a step after step c of entering a gemstone size.

12. The electronic device implemented method of claim 11 wherein the gemstone size is entered by entering a length, width and height of a gemstone.

13. The electronic device implemented method of claim 8 wherein the at least one gemstone characteristic selected from a list of predetermined gemstone characteristics is a gemstone outline selected from a list of predetermined gemstone outlines.

14. The electronic device implemented method of claim 8 wherein the at least one gemstone characteristic selected from a list of predetermined gemstone characteristics is a gemstone girdle selected from a list of predetermined gemstone girdles.

15. The electronic device implemented method of claim 8 wherein the at least one gemstone characteristic selected from a list of predetermined gemstone characteristics is a gemstone bulge selected from a list of predetermined gemstone bulges.

16. The electronic device implemented method of claim 8 further comprising a step after step b of selecting a gemstone type from a list of predetermined gemstone types.

17. An electronic device implemented method of calculating a weight of a gemstone using an electronic device, said method comprising the steps of:
a. installing said method in an electronic device;
b. initiating said method in the electronic device;
c. selecting at least one gemstone type from a list of predetermined gemstone types;
d. selecting at least one gemstone shape from a list of predetermined gemstone shapes;
e. entering a gemstone size;
f. selecting at least one gemstone outline from a list of predetermined gemstone outlines;
g. selecting at least one gemstone girdle from a list of predetermined gemstone girdles;
h. selecting at least one gemstone bulge from a list of predetermined gemstone bulges;
i. calculating a weight of a gemstone by processing said at least one gemstone characteristic within a gemstone weight algorithm; and
j. displaying the gemstone weight on the electronic device.

18. The electronic device implemented method of claim 17 wherein the list of predetermined gemstone shapes includes round, cushion, oval, marquise, pear, heart, emerald, princess, radiant and cabochon.

19. The electronic device implemented method of claim 17 wherein the list of predetermined gemstone outlines includes medium, fat and very fat.

20. The electronic device implemented method of claim 17 wherein the list of predetermined gemstone girdles includes thin, medium, thick, very thick and extremely thick.

21. The electronic device implemented method of claim 17 wherein the list of predetermined gemstone bulges includes no bulge, visible bulge and very visible bulge.

22. A system for calculating a weight of a gemstone comprising:
a means for selecting at least one gemstone characteristic from a list of predetermined gemstone characteristics;
a means for calculating a weight of a gemstone by processing said at least one gemstone characteristic within a gemstone weight algorithm; and
a means for displaying the gemstone weight on the electronic device.

23. The system of claim 22 further comprising:
a means for installing a method of calculating a weight of a gemstone in an electronic device; and
a means for initiating said method in the electronic device.

24. The system of claim 22 wherein:
said means for selecting at least one gemstone characteristic from a list of predetermined gemstone characteristics is via a drop-down list.
